(19) United States
(12) Patent Application Publication
(10) Pub. No.: US 2024/0328016 A1
(43) Pub. Date: Oct. 3, 2024

(54) CONTROLLER

(71) Applicant: HONDA MOTOR CO., LTD., TOKYO (JP)

(72) Inventor: Tomohiro TAKAYANAGI, WAKO-SHI (JP)

(21) Appl. No.: 18/588,526

(22) Filed: Feb. 27, 2024

(30) Foreign Application Priority Data
Mar. 28, 2023 (JP) 2023-051373

(51) Int. Cl. C25B 15/021; C25B 1/04; C25B 9/23; C25B 15/027

(52) U.S. Cl. CPC C25B 15/021; C25B 1/04; C25B 9/23; C25B 15/027

(57) ABSTRACT

When an instruction to activate a water electrolysis stack is received, a controller controls a water supplier and a water temperature regulator to supply water at a temperature lower than a predetermined temperature to the water electrolysis stack, and controls a power supply device to raise a current value of electric current supplied to a membrane electrode assembly from zero to a rated value at once.

### CROSS-REFERENCE TO RELATED APPLICATIONS

This application is based upon and claims the benefit of priority from Japanese Patent Application No. 2023-051373 filed on Mar. 28, 2023, the contents of which are incorporated herein by reference.

### BACKGROUND OF THE INVENTION

### Field of the Invention

The present invention relates to a controller for an electrolysis system.

### Description of the Related Art

In recent years, there has been research and development on electrolysis systems including water electrolysis stacks that contribute to energy efficiency to ensure that more people can have access to affordable, reliable, sustainable, and modern energy.

A water electrolysis stack carries out electrolysis of water and produces a hydrogen gas and an oxygen gas. JP 2010-059503 A discloses a method for activating a water electrolysis stack. This activating method sets an upper limit for the stack voltage and incrementally increases electric current to a rated value while monitoring the stack voltage and the electric current flowing through the water electrolysis stack.

### SUMMARY OF THE INVENTION

Recently, it has been desired to reduce, at the activation of the water electrolysis stack, the concentration of hydrogen gas that enters, via an electrolyte membrane, into an oxygen gas generated by water electrolysis.

An object of the present invention is to solve the aforementioned problems.

A controller for controlling: a water supplier that supplies water to a water electrolysis stack provided with a membrane electrode assembly including an electrolyte membrane, an anode electrode, and a cathode electrode; a water temperature regulator that regulates a temperature of the water supplied to the water electrolysis stack; and a power supply device that supplies electric current to the membrane electrode assembly, the controller including one or more processors for executing computer-executable instructions, wherein, when receiving the instructions to activate the water electrolysis stack, the controller controls the water supplier and the water temperature regulator to supply the water at a temperature lower than a predetermined temperature to the water electrolysis stack, and controls the power supply device to raise a current value of the electric current supplied to the membrane electrode assembly from zero to a rated value at once.

According to the above aspect, it is possible to reduce, at the activation of the water electrolysis stack, the concentration of hydrogen gas that enters, via an electrolyte membrane, into an oxygen gas generated by water electrolysis.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating an electrolysis system according to an embodiment; and

FIG. 2 is a flowchart showing an activation process.

### DETAILED DESCRIPTION OF THE INVENTION

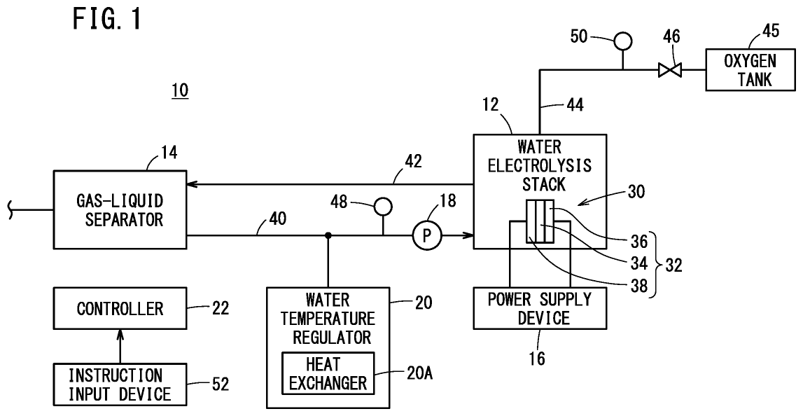

FIG. 1 is a schematic diagram illustrating an electrolysis system 10 according to an embodiment. The electrolysis system 10 includes a water electrolysis stack 12, a gas-liquid separator 14, a power supply device 16, a water supplier 18, a water temperature regulator 20, and a controller 22.

The water electrolysis stack 12 has a plurality of unit cells 30 for electrolyzing water. Each unit cell 30 has the same configuration. FIG. 1 shows only one unit cell 30. The unit cell 30 has a membrane electrode assembly 32. The membrane electrode assembly 32 includes an electrolyte membrane 34, an anode electrode 36, and a cathode electrode 38. The electrolyte membrane 34 is, for example, an anion exchange membrane capable of transporting hydroxide ions OH⁻. The electrolyte membrane 34 is sandwiched between the anode electrode 36 and the cathode electrode 38.

In the unit cell 30, water is electrolyzed based on electric current supplied to the membrane electrode assembly 32. Water is supplied to the cathode electrode 38 of each unit cell 30 via a water supply path 40. The cathode electrode 38 decomposes part of water into hydrogen ions H⁺ and hydroxide ions OH⁻ by electrochemical reaction.

The hydrogen ions H⁺ receive electrons at the cathode electrode 38 and become hydrogen gas. The hydrogen gas obtained in each unit cell 30 flows out to a water discharge path 42 together with the water that has not been electrolyzed.

The hydroxide ions OH⁻ migrate to the anode electrode 36 through the electrolyte membrane 34. The hydroxide ions OH⁻ that have migrated to the anode electrode 36 emit electrons from the anode electrode 36. When the hydroxide ions OH⁻ release electrons, oxygen gas and water are generated. The oxygen gas obtained in each unit cell 30 is stored in, for example, an oxygen tank 45 through an oxygen supply path 44.

A pressure control valve 46 is provided on the oxygen supply path 44. The pressure control valve 46 maintains the pressure of oxygen gas generated at the anode electrode 36 of each unit cell 30 at a predetermined pressure, for example, 1-100 MPa. In each unit cell 30, a large differential pressure is generated between the anode electrode 36 and the cathode electrode 38 via the electrolyte membrane 34. Due to this differential pressure, most of the water generated at the anode electrode 36 is returned to the cathode electrode 38 through the electrolyte membrane 34. In addition, crossleak is reduced, in which hydrogen gas generated at the cathode electrode 38 moves to the anode electrode 36 through the electrolyte membrane 34. As examples of the pressure control valve 46, there can be raised a solenoid valve, a back pressure valve, or the like the opening degree of which can be adjusted.

The gas-liquid separator 14 separates the hydrogen-containing water supplied from the water electrolysis stack 12 through the water discharge path 42 into liquid water and hydrogen gas. The liquid water separated by the gas-liquid separator 14 is supplied to the water electrolysis stack 12 through the water supply path 40. That is, the gas-liquid separator 14 is a source of water supplied to the water electrolysis stack 12. The hydrogen gas separated by the gas-liquid separator 14 may be supplied to, for example, an electrochemical hydrogen pump (not shown).

The power supply device 16 is a device that supplies the electric current to the membrane electrode assembly 32 of each unit cell 30. The power supply device 16 operates under the control of the controller 22. The power supply device 16 applies voltage to the anode electrode 36 and the cathode electrode 38 and supplies the electric current between the anode electrode 36 and the cathode electrode 38. The power supply device 16 is configured to be able to adjust the magnitude of the electric current (current value) supplied between the anode electrode 36 and the cathode electrode 38. The current value is adjusted by the controller 22.

The water supplier 18 is a device that supplies water to the water electrolysis stack 12. The water supplier 18 operates under the control of the controller 22. The water supplier 18 is provided on the water supply path 40. The water supplier 18 may be a pump or a valve. FIG. 1 shows an example where the water supplier 18 is a pump.

The water temperature regulator 20 is a device that regulates the temperature of the water supplied to the water electrolysis stack 12. The water temperature regulator 20 operates under the control of the controller 22. For example, the water temperature regulator 20 may heat or cool the water supplied to the water electrolysis stack 12 by regulating the amount of heat in the heat exchanger 20A that exchanges heat with the water within the water supply path 40. In this case, the water temperature regulator 20 regulates the amount of heat in the heat exchanger 20A in a manner so that a deviation between the water temperature detected by the temperature sensor 48 provided on the water supply path 40 and the target temperature is reduced, for example.

The controller 22 is a computer that manages the electrolysis system 10. A plurality of sensors are connected to the controller 22. The sensors include a temperature sensor 48 and a pressure sensor 50.

The temperature sensor 48 is a sensor that detects the temperature. The temperature sensor 48 is provided on the water supply path 40 that communicates with the cathode electrode 38 of each unit cell 30. The temperature sensor 48 detects the temperature of the water supplied to the water electrolysis stack 12. The temperature of the water detected by the temperature sensor 48 is supplied to the controller 22.

The pressure sensor 50 is a sensor that detects the pressure of gas. The pressure sensor 50 is provided on the oxygen supply path 44 that communicates with the anode electrode 36 of each unit cell 30. In this embodiment, the pressure sensor 50 is provided on the oxygen supply path 44 between the pressure control valve 46 and the water electrolysis stack 12. The pressure sensor 50 detects the pressure of the gas produced at the anode electrode 36. The gas includes oxygen gas generated from hydroxide ions OH⁻ that migrated to the anode electrode 36 and a small amount of hydrogen gas generated together with the oxygen gas. The pressure of the gas detected by the pressure sensor 50 is supplied to the controller 22.

Also, an instruction input device 52 is connected to the controller 22. The instruction input device 52 is a device that can input at least an activation instruction for the water electrolysis stack 12 or a stop instruction for the water electrolysis stack 12. The instruction input device 52 may be a lever-type on-off switch.

The controller 22 includes one or more processors and a storage medium. The storage medium may be constituted by volatile and non-volatile memory. Examples of the processors include a CPU, an MCU, etc. Examples of volatile memory include RAM. Examples of the non-volatile memory include ROM and flash memory. The processors execute computer-executable instructions to cause the controller 22 to control a plurality of devices. The devices include the power supply device 16, the water supplier 18, and the water temperature regulator 20.

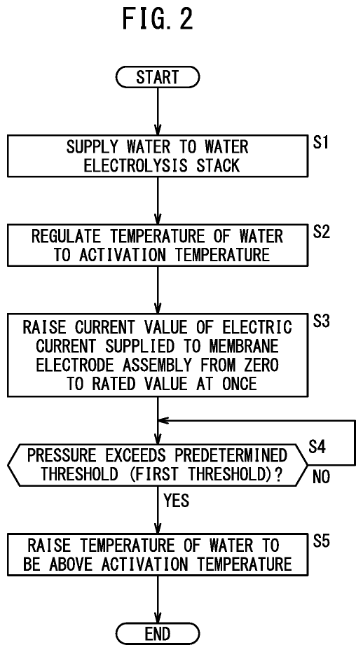

Upon receiving the activation instruction to activate the water electrolysis stack 12, the controller 22 starts the activation process. FIG. 2 is a flowchart showing the activation process. In the state before the activation of the water electrolysis stack 12 (stop state), the power supply device 16, the water supplier 18, and the water temperature regulator 20 are stopped.

In step S1, the controller 22 controls the water supplier 18 to supply water to the water electrolysis stack 12 while circulating water between the water supply path 40 and the water discharge path 42. In this case, no electric current is supplied to the membrane electrode assembly 32 of each unit cell 30. Therefore, water electrolysis is not substantially performed at each unit cell 30.

In step S2, the controller 22 controls the water temperature regulator 20 to regulate the temperature of the water supplied to the water electrolysis stack 12 to the activation temperature. The activation temperature is stored in advance in the storage medium as a target temperature at the time of activating the water electrolysis stack 12. The activating temperature is set lower than a predetermined temperature at which the water electrolysis efficiency in the water electrolysis stack 12 becomes good. For example, the activation temperature is 30° C. The activation temperature is selected from a range of 20° C. to 70° C. When a deviation between the temperature of the water detected by the temperature sensor 48 and the activation temperature is equal to or less than a predetermined value, the controller 22 proceeds to step S3.

In step S3, the controller 22 controls the power supply device 16 to raise the current value of the electric current supplied to the membrane electrode assembly 32 from zero to a rated value at once. That is, the controller 22 instantaneously increases the current value supplied to the membrane electrode assembly 32. In other words, a current instruction value from the controller 22 is not an instruction value to gradually increase the electric current, but an instruction value of a rated value is output to the power supply device 16. Therefore, the current value of the electric current supplied to the membrane electrode assembly 32 is not controlled to increase in a stepwise manner. It should be noted that “at once” or “instantaneously” means a case where the time taken for the current value to reach the rated value from zero is 2 seconds or less. The zero current value includes a case where a weak electric current of such a degree that ion exchange does not occur is supplied to the membrane electrode assembly 32.

When the electric current supplied to the membrane electrode assembly 32 is raised from zero to the rated value at once, the amount of hydrogen gas in the flow path communicating with the anode electrode 36 of each unit cell 30 is small. This has been revealed by experimental results. The following reasons may account for such experimental results.

That is, in the present embodiment, the temperature of the water supplied to the water electrolysis stack 12 is regulated to be lower than a predetermined temperature at which the water electrolysis efficiency becomes good (step S2). Therefore, the amount of hydrogen gas generated at the cathode electrode 38 reduces compared to a case where the temperature of water is higher than the predetermined temperature. As a result, the amount of hydrogen gas that moves through the electrolyte membrane 34 to the anode electrode 36 reduces. On the other hand, when the temperature of water is regulated to be lower than a predetermined temperature, hydroxide ions OH⁻ that move from the cathode electrode 38 to the anode electrode 36 through the electrolyte membrane 34 reduce.

In addition, in this embodiment, the electric current supplied to the membrane electrode assembly 32 is raised from zero to the rated value at once. Therefore, even if the hydroxide ions OH⁻ migrating to the anode electrode 36 reduce, the amount of oxygen gas generated per unit time at the anode electrode 36 is larger than that in a case where the electric current supplied to the membrane electrode assembly 32 gradually increases.

That is, a relative amount of hydrogen gas moving to the anode electrode 36 with respect to the oxygen gas generated at the anode electrode 36 reduces. As a result, it is considered that the amount of hydrogen gas in the flow path communicating with the anode electrode 36 of each unit cell 30 reduces.

When the current value supplied to the membrane electrode assembly 32 is increased at once, the controller 22 proceeds to step S4. In step S4, the controller 22 compares the pressure detected by the pressure sensor 50 with a predetermined first threshold. The first threshold is a threshold that is compared with the pressure detected by the pressure sensor 50 during the activation process. The first threshold is stored in advance in the storage medium of the controller 22.

If the pressure is less than or equal to the first threshold, the controller 22 remains at step S4. On the other hand, if the pressure exceeds the first threshold, the controller 22 proceeds to step S5. In step S5, the controller 22 controls the water temperature regulator 20 to raise the temperature of the water supplied to the water electrolysis stack 12 to be above the activation temperature. In this case, the water temperature regulator 20 heats the water supplied to the water electrolysis stack 12. This increases the movement speed of hydroxide ions OH⁻ moving through the electrolyte membrane 34, and as a result, the water electrolysis efficiency in the water electrolysis stack 12 is enhanced. In other words, the electrolysis efficiency can be adjusted by the behavior of the amount of gas generated by the electrolysis of water.

When the controller 22 confirms that the temperature detected by the temperature sensor 48 is higher than the activation temperature, the controller 22 ends the activation process.

After ending the above activation process, the controller 22 starts a steady operation process. In the steady operation process, the temperature of the water supplied to the water electrolysis stack 12 is kept at a predetermined temperature (normal temperature) higher than the activation temperature. In addition, in the steady operation process, the electric current supplied to the membrane electrode assembly 32 of the water electrolysis stack 12 is kept at the rated value.

Upon receiving the stop instruction to stop the water electrolysis stack 12, the controller 22 starts a stopping process. In this case, the controller 22 controls the power supply device 16 to gradually reduce the current value supplied to the membrane electrode assembly 32. In addition, the controller 22 controls the water temperature regulator 20 to gradually decrease the temperature of the water supplied to the water electrolysis stack 12.

This gradually slows down the movement speed of hydroxide ions OH⁻ moving through the electrolyte membrane 34, and also reduces the amount of oxygen gas generated at the anode electrode 36. Therefore, the pressure of the oxygen gas in the oxygen supply path 44 is gradually reduced. As a result, the hydrogen gas that has passed through the electrolyte membrane 34 from the cathode electrode 38 can be inhibited from mixing into the oxygen gas, as compared with the case where the pressure of the oxygen gas is rapidly reduced. As a result, the applications of the pressured-reduced and high-purity oxygen gas are broadened. In addition, the load on the electrolyte membrane 34 can be reduced, as compared with the case where the pressure of the oxygen gas is reduced rapidly.

Thereafter, when the pressure detected by the pressure sensor 50 becomes equal to or lower than a predetermined second threshold, the controller 22 stops the water supplier 18 and ends the stopping process. The second threshold is a threshold that is compared with the pressure detected by the pressure sensor 50 during the stopping process. The second threshold is stored in advance in the storage medium of the controller 22. The second threshold may be the same as or smaller than the first threshold.

The above embodiment may be modified as follows.

For example, in step S4, the controller 22 may measure a time period since the supply of electric current to the membrane electrode assembly 32 is started. In this case, when a predetermined time has elapsed since the supply of the electric current to the membrane electrode assembly 32 was started, the controller 22 proceeds to step S5.

In this way, after a predetermined time has elapsed since the supply of electric current to the membrane electrode assembly 32 was started, the controller 22 can set the temperature of the water supplied to the water electrolysis stack 12 to be higher than the activation temperature. In this case, it is avoided that the pressure detected by the pressure sensor 50 is compared with a predetermined threshold. Therefore, the load on the controller 22 can be reduced, compared to the embodiment.

Further, for example, the source of water supplied to the water electrolysis stack 12 is the gas-liquid separator 14 in the above embodiment, but is not limited to this example. For example, the source of water may be a water tank. Alternatively, the source of water may be a water supply line connected to a water treatment facility.

Also for example, the electrolysis system 10 is an AEM water electrolysis system in the above embodiment, but is not limited to this example. For example, the electrolysis system 10 may be a PEM water electrolysis system. In the case of the AEM water electrolysis system, the membrane electrode assembly 32 including the electrolyte membrane 34 which is an anion exchange membrane is provided in the water electrolysis stack 12 as described above. On the other hand, in the case of the PEM water electrolysis system, a membrane electrode assembly 32 including an electrolyte membrane 34 which is a proton exchange membrane is provided in the water electrolysis stack 12.

With respect to the above embodiments, the following additional Appendices are further disclosed.

### Appendix 1

The present disclosure is a controller (22) for controlling: a water supplier (18) that supplies water to a water electrolysis stack (12) provided with a membrane electrode assembly (32) including an electrolyte membrane (34), an anode electrode (36), and a cathode electrode (38); a water temperature regulator (20) that regulates a temperature of the water supplied to the water electrolysis stack; and a power supply device (16) that supplies electric current to the membrane electrode assembly, the controller (22) comprising one or more processors that execute computer-executable instructions, wherein when receiving the instructions to activate the water electrolysis stack, the controller controls the water supplier and the water temperature regulator to supply the water at a temperature lower than a predetermined temperature to the water electrolysis stack, and controls the power supply device to raise a current value of the electric current supplied to the membrane electrode assembly from zero to a rated value at once.

It is possible to reduce a relative amount of hydrogen gas permeating through the electrolyte membrane with respect to oxygen gas. As a result, the mixing of hydrogen gas generated by the electrolysis of water and oxygen gas generated by the electrolysis of the water can be reduced.

### Appendix 2

The present disclosure is the controller described in Appendix 1, wherein the controller may control the water temperature regulator to raise the temperature of the water supplied to the water electrolysis stack to be above the predetermined temperature when the pressure detected by a pressure sensor (50) provided on a flow path communicating with the anode electrode exceeds a threshold after the electric current starts to be supplied to the membrane electrode assembly. This allows the electrolysis efficiency to be adjusted by the behavior of the amount of gas generated by the electrolysis of water.

### Appendix 3

The present disclosure is the controller described in Appendix 1, wherein the controller may control the water temperature regulator to raise the temperature of the water supplied to the water electrolysis stack to be above the predetermined temperature when a predetermined time elapses after the electric current starts to be supplied to the membrane electrode assembly. This allows the electrolysis efficiency to be adjusted by the behavior of the amount of gas generated by the electrolysis of water, while reducing the load on the controller.

### Appendix 4

The present disclosure is the controller described in any one of Appendices 1 to 3, wherein the controller may control the power supply device to gradually reduce the current value and control the water temperature regulator to gradually reduce the temperature of the water when receiving the instructions to stop the water electrolysis stack. This allows the electrolysis of water to be gradually stopped. As a result, the mixing of hydrogen gas generated by the electrolysis of water and oxygen gas generated by the electrolysis of water can be reduced compared to the case where the electrolysis of water is immediately stopped.

The present invention is not limited to the above disclosure, and various configurations can be employed without departing from the gist of the present invention.

1. A controller for controlling:
a water supplier that supplies water to a water electrolysis stack provided with a membrane electrode assembly including an electrolyte membrane, an anode electrode, and a cathode electrode;
a water temperature regulator that regulates a temperature of the water supplied to the water electrolysis stack; and
a power supply device that supplies electric current to the membrane electrode assembly,
wherein the controller comprises one or more processors that execute computer-executable instructions,
when receiving the instructions to activate the water electrolysis stack, the controller controls the water supplier and the water temperature regulator to supply the water at a temperature lower than a predetermined temperature to the water electrolysis stack, and controls the power supply device to raise a current value of the electric current supplied to the membrane electrode assembly from zero to a rated value at once.

2. The controller according to claim 1, wherein
the controller that controls the water temperature regulator to raise the temperature of the water supplied to the water electrolysis stack to be above the predetermined temperature when the pressure detected by a pressure sensor provided on a flow path communicating with the anode electrode exceeds a threshold after the electric current starts to be supplied to the membrane electrode assembly.

3. The controller according to claim 1, wherein
the controller controls the water temperature regulator to raise the temperature of the water supplied to the water electrolysis stack to be above the predetermined temperature when a predetermined time elapses after the electric current starts to be supplied to the membrane electrode assembly.

4. The controller according to claim 1, wherein
when receiving the instructions to stop the water electrolysis stack, the controller controls the power supply device to gradually reduce the current value and controls the water temperature regulator to gradually reduce the temperature of the water.
